(19) United States
(12) Patent Application Publication
(10) Pub. No.: US 2005/0278226 A1
(43) Pub. Date: Dec. 15, 2005

(54) A business concept whereby websites that are branded to be germane to a particular metropolitan area, create a market in that particular metropolitan area where unsigned artists who originate from that metropolitan area are able to offer their CD's to the consuming public for sell via download or mail order.

(76) Inventor: Michael Morris, Florissant, MO (US)

Correspondence Address: MICHAEL MORRIS, 16857 HEATHER MOOR DRIVE, FLORISSANT, MO, 63034, US

(21) Appl. No.: 10/710,048

(22) Filed: Jun. 15, 2004

(51) Int. Cl. G06F 17/60

(52) U.S. Cl. 705/26

(57) ABSTRACT

A business concept that uses a website and a marketing campaign to create a market whereby an unsigned artist, who originates from a particular metropolitan area, will be able to sell their music to the general public via download or mail order. The website is branded to a particular metropolitan area and features only artists who've originated from that particular metropolitan area. The unsigned artist, who has created a sellable quality CD will now have a vehicle through which they can market and sell their product to a worldwide audience via the website.

### BACKGROUND OF INVENTION

Traditionally, the music industry has been a closed society in which it is very hard for an artist, new or old, to get in. An artist who has original music would put together a demo and would shop it around in an effort to connect with a music industry personality. More times than not, no matter how good the music is, this search for an inlet comes up empty. And, if the artist is lucky enough to get their demo to an insider they wind up signing themselves to a record label. Then they are at the mercy of that label to put together a sellable quality record and push the record through distribution channels. A lot of times, the artists' work sits on a shelf and the artist can't do anything about it.

With the advent of the CD and with current technology for creating CD's becoming more affordable, it has now become commonplace for an artist to put together a sellable quality CD using their own resources and without signing their souls over to a record label. Artist who create their own CD's usually sell them at their shows, or out of the trunk of their cars, so to speak.

And now, with the Internet and current technology for digital downloading, what I am proposing is a website that will provide a unique worldwide distribution channel for the local unsigned artist. The concept is to create a website and brand it via marketing campaigns to a specific metropolitan area. The first of such websites is called STLSounds.com. STLSounds.com will not be shrouded is secrecy but will become well known (to artist in and around the St. Louis, Mo. area) as the website where an artist, who has a sellable quality CD, can offer their CD for sell to the general public via download or mail order. St. Louis has become a hot spot for new artist and because of artist such as Nelly and Chingy, St. Louis has now gained recognition from the music industry as well as music fans the world over. STLSounds.com will allow fans of music around the world to hear and buy music from up and coming St. Louis artist before they “blow-up” or make it big. And, I will also attempt to get the right to distribute the music of already established or signed St. Louis artists so that STLSounds.com can be a one-stop shop for music fans who want to purchase music created by St. Louis artists.

This same concept can be implemented in areas such as Atlanta, N.Y., LA, Memphis, Chicago etc.

### DETAILED DESCRIPTION

This idea consists primarily of a website and a marketing campaign, which creates a market in which artists of all genres, in a particular metropolitan area, will have an opportunity to present and sell his/her music to a worldwide fan base. The marketing campaign brands the website (the first of which is STLSounds.com) to a particular metropolitan area (the first of which is St. Louis, Mo.). There are two target audiences for the marketing campaign. One audience is unsigned artists, record labels and/or anyone who has rights to distribute a CD created by an artist who currently lives in or claims to be from the particular metropolitan area. To target this audience the marketing campaign will use billboards, fliers, local newspapers, local radio and local television. Every ad is aimed at branding the website (STLSound.com for instance) as being the platform created solely for the particular metropolitan based artist (St. Louis based artists for instance) to showcase and sell their CD's to a worldwide audience. The other audience is the general public. To target this audience the marketing campaign will use local and national publications and other established means. The ads will let the public know that a website exists, that consists solely of music created by artist in and around a particular metropolitan area, where they can listen to and, if they like, purchase music via download or mail order. It is also anticipated that the artists themselves will announce or advertise the website (at their concerts and other venues) as the place to go to pick up their CD.

The website will use existing technologies to enable the following: Present the artists via pictures and biography. Play the artist CD (in whole or in part). Play the artist music video if it exists. Provide a shopping cart for purchases. Allow for secure payment via credit card. Deliver the purchase to the purchasers PC via download. Create an invoice in the event of a mail order. Track and properly account for (by artist) all purchases. Calculate and report artist royalties at regular intervals. And any other necessary features not listed here.

The homepage of the website will present images and a greeting that further brands the site to the particular metropolitan area. It will provide links to other websites of local interest and will provide space for advertisers. Also, on the homepage, there will be a button or link for each genre of music (one for R&B, Hip Hop, Rock, Alternative, Gospel etc.) The music fan will click on one of these buttons to go to the next page. This next page will provide a button or link for each artist in the category chosen. The fan will click on a particular artist link and will be presented with a page that describes the artist via pictures and biography. Also, on this page, there will be a button or link for the artist's CD or multiple links in the event the artist has more than one CD. The fan will click on the CD link and will be presented with the next page. This next page will give the fan an opportunity to listen to various tracks from the CD and/or view music videos if the artist has provided them. This page will also have an “add to shopping cart” button and a “check out” button. If the fan clicks the “add to shopping cart” button, the CD selection is recorded and the fan will be able to continue shopping by visiting other CD pages and adding selections to the shopping cart. When the fan is done shopping they will click the “check out” button, which will take them to a page that gathers appropriate information to complete the sell. The fan will be given the option to download or mail order. If mail order is chosen, an additional fee for shipping and handling will be added to the invoice. A secure service such as PAYPAL or some other well-known secure payment service will be used to complete a credit card transaction. Once the credit card transaction has been verified as successful, the artist royalty database is updated with the appropriate information regarding the sale. If download is chosen, current methods for download will be used to guarantee the download is successful. If mail order is chosen, an invoice will be generated so that the order can be filled and shipped. The website will also have a secured way for the artist to access his royalty information online.

The following is an example of the agreement between the Artist and the website owner.

Digital Distribution Agreement

WHEREAS, ______ (hereinafter “Artist”) is the holder of a Copyright for a Sound Recording entitled ______ (“The Recording”); and WHEREAS, Morris Management Group, LLC (hereinafter “Distributor”) has the capabilities and expertise to generate sales of The Recording through its Website “STLSounds.com” through digital downloads and mail order distribution.

Artist grants to Distributor a non-exclusive license to sell, copy, sublicense, distribute and otherwise exploit The Recording throughout the Territory, including, but not limited to those via the Internet, as well as all digital storage, download and transmission rights, whether now known or existing in the future.

Term

This agreement shall continue for a period of one year beginning on the date signed by the parties. Distributor shall be granted two (2) one year options to renew this agreement, which shall be deemed exercised by Distributor unless Distributor notifies Artist that he does not wish to exercise the options. Distributor reserves the right to terminate this Agreement with a written thirty day notice to Artist at any time during the term of this Agreement.

Rights Granted

During the term of this Agreement, Artist grants to Distributor the rights to use Artist's name, professional and/or group name, photographs and other images or likenesses of Artist, biographical and and/or other information concerning Artist pursuant to the sales and distribution of The Recording.

Initial Costs

Artist will pay, upon execution of this Agreement, and in any case prior to Distributor's posting of Artist's product and material on the website, a setup fee of ______. This fee shall be non-refundable. Artist shall be responsible for all costs of shipping of The Recordings between Artist and Distributor.

Distribution Procedure

Artist shall provide the following to Distributor for distribution of The Recording:

______ copies of fully mastered CD, which may be in CD form, or which may be in the form of an MP3 file. Artist shall also provide photos, bio and other information Artist wishes to have posted on the website, which information may be in the form of a scanable document or on a CD as a ______ file.

For Physical Distribution: ______ copies of manufactured, packaged CD's in a labeled carton. CD's must be shrink wrapped and in retail ready jewel cases or other retail ready packages.

Payments

Distributor will pay to Artist seventy percent (70%) of Net Income derived from sales of The Recording.

Accountings

Distributor shall provide an accounting to Artist on a quarterly basis, beginning on the first calendar quarter after the term begins. Accountings shall be sent to Artist at the current address that Distributor has for Artist and in the event that Artist's address changes, Artist shall be responsible for updating this information in writing to Distributor.

Notices

All notices pursuant to this Agreement shall be sent to the parties at the addresses listed below, via US Mail, Express Courier, or Facsimile:

Distributor

Morris Management Group, LLC, 16857 Heather Moor Dr., Florissant, Mo. 63034

Artist

______

Warranties and Indemnification

Artist warrants and represents that he/she has the right to grant to Distributor all of the rights granted herein. Artist warrants that he/she is not currently under any recording, production or distribution contract which would prevent or forbid Artist from distributing Artist's CD's through Distributor.

In the event that any of the compositions contained in The Recording are co-written with any other persons, Artist acknowledges and warrants that he/she has obtained all necessary clearances and agreements from the co-writers or co-owners of the compositions which shall enable Distributor to engage in the sale of the recordings.

The Recording contains samples YES ______ NO ______. In the event that Artist has indicated that the Recording contains one or more samples, Artist warrants that sample clearances have been obtained from both the writer/publisher of the sampled work and from the record company that owns that master of the sampled work. In the event that Artist has indicated that the Recording contains no samples, this shall mean that there are no samples in The Recording. Artist agrees to indemnify Distributor in the event that there are any undisclosed samples.

The Recording contains covers of previously recorded songs YES ______ NO ______. In the event that Artist has indicated that the Recording contains one or more covers, Artist warrants that the appropriate mechanical royalties have been paid and the appropriate mechanical licenses have been obtained. In the event that Artist has indicated that the Recording contains no covers, Artist agrees to indemnify Distributor in the event that there are any undisclosed covers.

Artist agrees to furnish the appropriate documentation to Distributor pursuant to the above upon request by Distributor and Distributor reserves the right to suspend distribution of Artist's recordings pending Distributor's receipt of the proper documentation.

Artist agrees to indemnify, reimburse, and hold Distributor, its officers, members, agents, representatives, successors, designees and assigns harmless from and against any and all liability, loss, damage, cost and expense (including court costs and reasonable attorney fees) arising out of or in connection with any claim by any third party which arises out of any breach of any of Artist's warranties herein, representations or agreements. Distributor shall not be responsible for any inadvertent error in any listing of The Recordings.

Other

This Agreement shall not be construed to create a partnership or joint venture between Artist and Distributor.

Distributor reserves the right to reject any recordings, artwork or other materials submitted by Artist.

Distributor shall have the right to assign its rights, under this Agreement in whole or in part.

This Agreement shall be governed by the laws of the State of Missouri. Any disputes arising under his Agreement shall be subject to the exclusive jurisdiction of the State or Federal Courts located in St. Louis County, Mo. or St. Louis City.

Definitions

The following words when used in this Agreement have the following meanings: “Territory” means the Universe. “Net Income” means Distributor's gross receipts directly from the sale of the Recordings, minus each and every cost incurred by Distributor which is specifically related to the sale of the Recordings (for physical sales this includes shipping and packaging costs).

IN WITNESS WHEREOF, the parties have entered into this agreement on the date first above written.

Morris Management Group, LLC (Distributor)
By ______ Michael Morris, Member
Date ______
Artist ______
Date ______

1. A website and a marketing campaign that creates a market in which unsigned artists from a particular metropolitan area can market and sell their music.

2. The marketing campaign will brand the website to a particular metropolitan area.

3. The marketing campaign will proclaim the website as being the exclusive and official website where unsigned artist in the area can market and sell their music to the general public via download or mail order.

4. The marketing campaign will let the general public know that a website exists whereby they can go to listen to and/or purchase music from artist who originate from that particular metropolitan area.

5. The website will cater to all musical genres.

6. The first of such websites is called STLSounds.com for the St. Louis Mo. Metropolitan Area.

7. This idea will be done for other metropolitan areas such as Memphis, N.Y., Atlanta, Los Angeles, etc.

8. The unsigned artist enters into a non-exclusive distribution agreement with the owner of the website.

9. The website will also attempt to enter into distribution agreements with already established or signed artists who originate from that particular metropolitan area.

10. The website will attempt to become a one stop shop where the music fan will be able to listen to and/or purchase music from artists, signed or unsigned, who originate from a particular metropolitan area.

11. The artist will be able to track their sells and royalties online through the website.
